(19) United States
(12) Patent Application Publication
(10) Pub. No.: US 2025/0292656 A1
(43) Pub. Date: Sep. 18, 2025

(54) SYSTEM AND METHOD FOR PROVIDING A POKER-SLOT HYBRID GAME

(71) Applicant: GameDayMatch LLC, Boca Raton, FL (US)

(72) Inventor: William Hogwood, Boca Raton, FL (US)

(21) Appl. No.: 19/080,708

(22) Filed: Mar. 14, 2025

Related U.S. Application Data
(60) Provisional application No. 63/566,079, filed on Mar. 15, 2024.

(51) Int. Cl. G07F 17/32

(52) U.S. Cl. CPC G07F 17/3262; G07F 17/3211; G07F 17/3267; G07F 17/3293

(57) ABSTRACT

A system and method for providing a poker-slot hybrid game that combines enjoyable aspects of slot machines (e.g., fast paced games where symbols can be used to form multiple winning combinations along multiple pathways) with enjoyable aspects of poker (e.g., the simple and easily-understood goal of forming one of a number of winning hands, deciding whether to hold or re-deal cards, clear and transparent pay tables with higher payouts for winning hands that are less likely to be formed, etc. A player places a wager and the program deals out the cards across a grid. The player may select any number of cards and swap them out for new cards to be re-dealt with the goal of the game to form a winning poker hand along a line of the grid, whether horizontal, vertical, or diagonal.

### CROSS-REFERENCE TO RELATED APPLICATIONS

This application claims priority to U.S. Prov. Pat. Appl. No. 63/566,079, filed Mar. 15, 2024, which is hereby incorporated by reference.

### FEDERAL FUNDING

None

### BACKGROUND

Slot machine games maintain immense popularity due to a combination of psychological and design factors. Each round offers the potential for immediate rewards, creating a sense of anticipation and excitement. Meanwhile, slot machine games are fast paced with a repetitive nature that many find soothing. Additionally, slot machine games provide intermittent rewards, which trigger the release of dopamine and create a pleasurable sensation. However, the outcomes most slot machine games are selected at random, even for slot machine games that give users the illusion of being in control (e.g., stopping the reels or choosing bonus rounds). Additionally, the payouts for some slot machine games (and even which combination of symbols provide any payout at all) can be challenging to understand.

By contrast, many people enjoy poker because long-term success relies heavily on skill, including understanding probabilities and odds, managing risk, and making strategic decisions (even though luck plays a role in the outcome of any individual hand). Unlike slot machine games, for instance, video poker games involves strategic decision-making. Players must choose which cards to hold and discard, directly impacting the outcome and adding a layer of engagement that many find appealing. Meanwhile, most video poker games have simple rules that are easy to learn and understand and provide easily understood payouts for different hands.

Accordingly, there is a need to combine enjoyable aspects of traditional slot machine games (e.g., fast paced games where symbols can be used to form multiple winning combinations along multiple pathways) with enjoyable aspects of poker (e.g., the simple and easily-understood goal of forming one of a number of winning hands, deciding whether to hold or re-deal cards, deciding which winning hand to attempt to form, clear and transparent pay tables with higher payouts for winning hands that are less likely to be formed, etc.)

### SUMMARY

In order to combine the best aspects of slot machine games and poker, disclosed is a platform for providing a poker-slot hybrid game. First, a player places a wager or a bet wherein the program deals out the cards across a grid. Upon the cards being dealt across the grid, the player may select any number of cards and swap them out for new cards to be re-dealt. The goal of each game is to obtain a winning poker hand in a line on the grid, whether the line be horizontal, vertical, or diagonal. Upon winning, the initial wager or bet is multiplied according to the value of the winning poker hand.

### BRIEF DESCRIPTION OF THE DRAWINGS

Aspects of exemplary embodiments may be better understood with reference to the accompanying drawings. The components in the drawings are not necessarily to scale, emphasis instead being placed upon illustrating the principles of exemplary embodiments.

FIG. 1 is an example view of a user interface for a poker-slot hybrid game according to exemplary embodiments.

FIG. 2 is another example view of the user interface of FIG. 1 according to exemplary embodiments.

FIG. 3 is another example view of the user interface of FIG. 1 according to exemplary embodiments.

FIG. 4 is another example view of the user interface of FIG. 1 according to exemplary embodiments.

FIG. 5 is another example view of the user interface of FIG. 1 according to exemplary embodiments.

FIG. 6 is another example view of the user interface of FIG. 1 according to exemplary embodiments.

FIG. 7 is another example view of the user interface of FIG. 1 according to exemplary embodiments.

FIG. 8 is another example view of the user interface of FIG. 1 according to exemplary embodiments.

FIG. 9 is another example view of the user interface of FIG. 1 according to exemplary embodiments.

FIG. 10 is an example view of another user interface according to other exemplary embodiments.

FIG. 11 is another example view of the user interface of FIG. 10 according to exemplary embodiments.

FIG. 12 is an example view of another user interface according to other exemplary embodiments.

FIG. 13 is another example view of the user interface of FIG. 12 according to exemplary embodiments.

FIG. 14 is a diagram of an architecture of the disclosed system according to exemplary embodiments.

### DETAILED DESCRIPTION

Reference to the drawings illustrating various views of exemplary embodiments is now made. In the drawings and the description of the drawings herein, certain terminology is used for convenience only and is not to be taken as limiting the embodiments of the present invention. Furthermore, in the drawings and the description below, like numerals indicate like elements throughout.

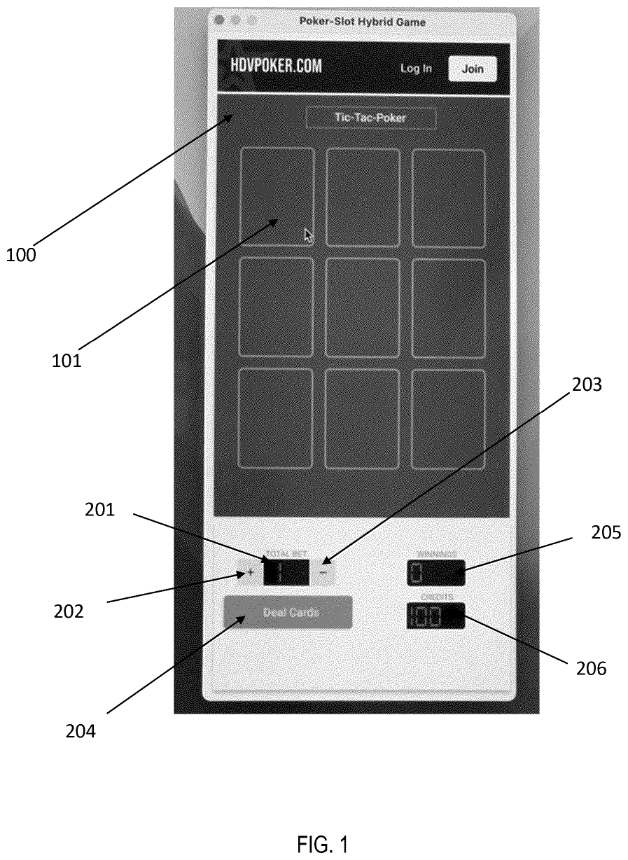

FIGS. 1-9 are example views of a user interface 100 for the poker-slot hybrid game according to exemplary embodiments.

In the embodiment of FIGS. 1-9, the user interface 100 includes nine spaces 101 arranged in a 3×3 grid. A card is placed in each of the nine spaces 101 when dealt. A portion of the user interface 100 (e.g., at the bottom as shown in FIG. 1) includes a number of user interface elements for the user to engage with the game. As shown in FIG. 1, for instance, the bottom of the user interface 100 includes a “deal cards” button 204, a “total bet” window 201 that displays the current wager specified by the user, a “+” button 202 that provides functionality for the user to increase the current wager, a “−” button 203 that provides functionality for the user to decrease the current wager, a “credits” window 206 that displays the number of total credits available to the user, and a “winnings” window 205 that displays the amount won in the most recent round.

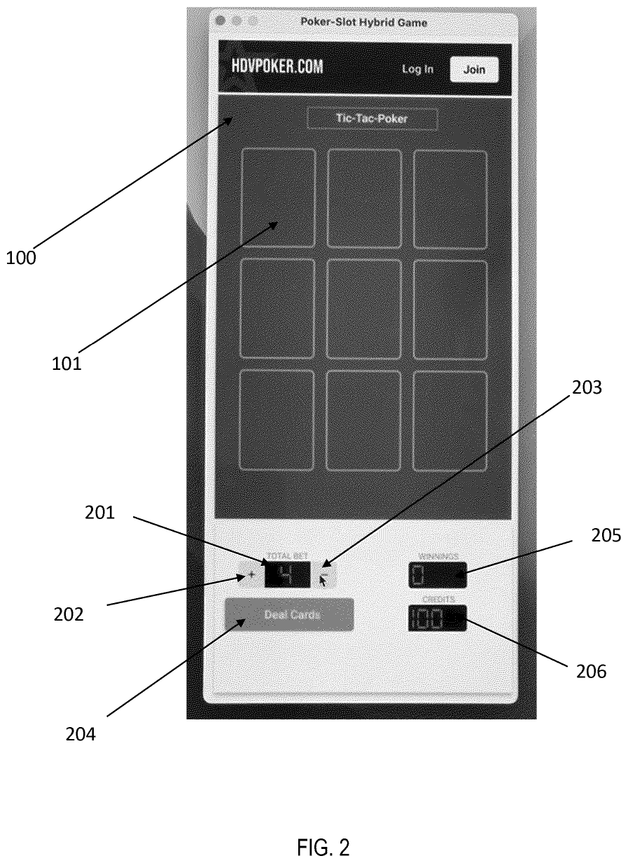

Like a traditional slot machine game, users select the amount of a current wager, which is deducted from a pool of available credits (purchased, won, or otherwise provided to the user), with the goal of forming one of a number of predetermined winning hands that are each associated with a predetermined prize amount. For each winning hand formed by the user, the prize amount associated with that winning hand is multiplied by the current wager specified by the user and added to the user's pool of available credits. In the example of FIG. 2, for instance, the user interface 100 provides functionality (via the “+” button 202 and the “−” button 203) for the user to set the amount of the current wager to 4 credits (as shown in the “total bet” window 201).

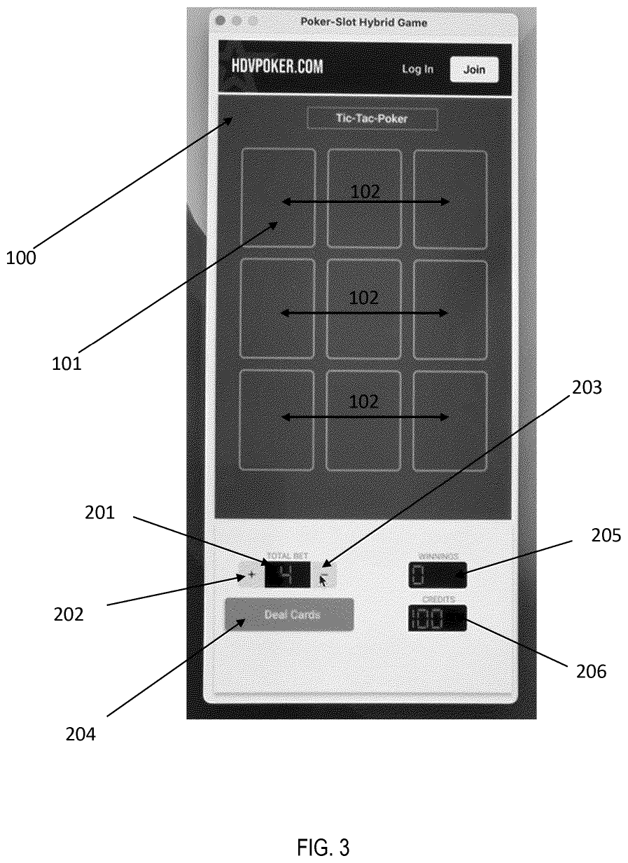

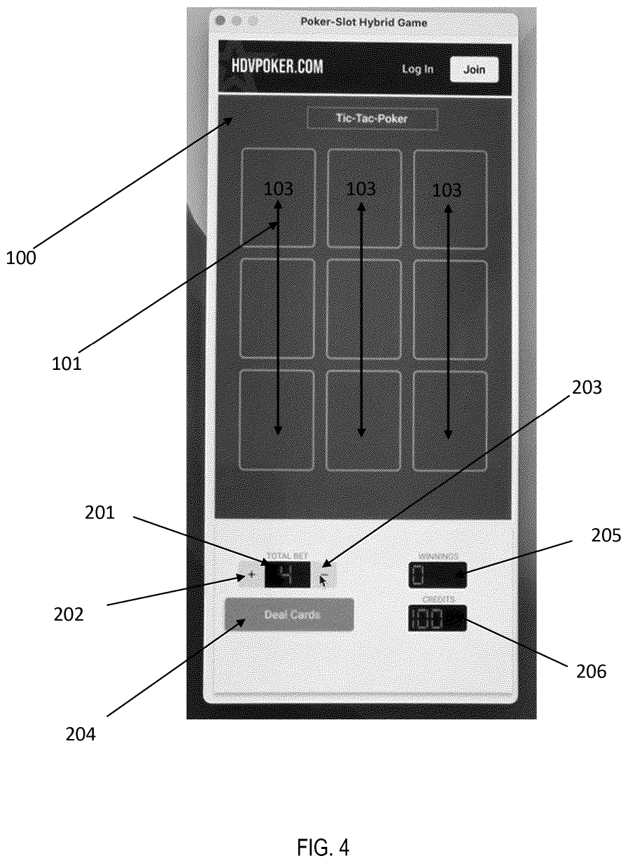

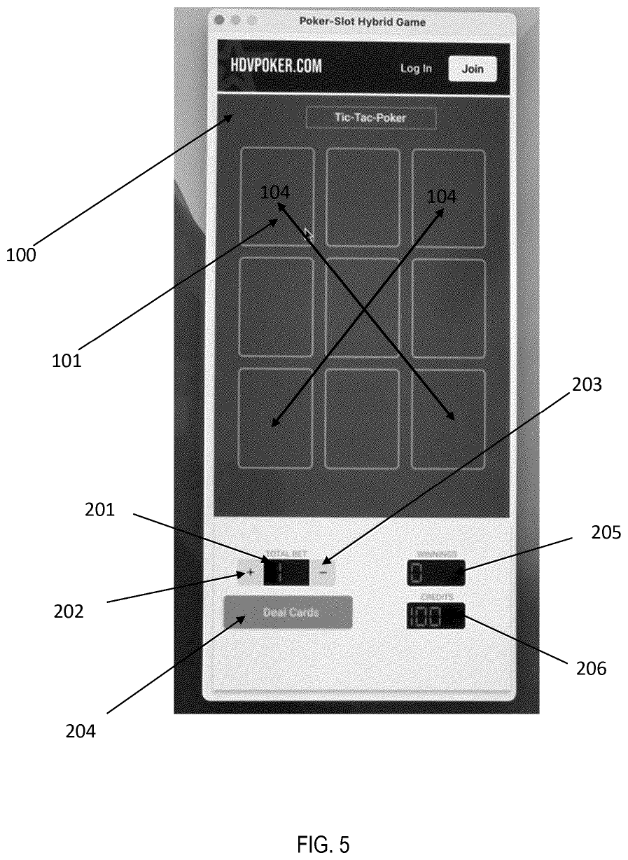

The user interface 100 provides functionality for the user to form a number of hands with the cards displayed in each of the spaces 101 being included in more than one hand. In embodiments of FIGS. 1-9 (where the user interface 100 includes a 3×3 grid), for instance, the user interface 100 may provide functionality for the user to form hands along each of the horizontal rows 102 shown in FIG. 3, along each of the vertical columns 103 shown in FIG. 4, and along both of the diagonal lines 104 shown in FIG. 5.

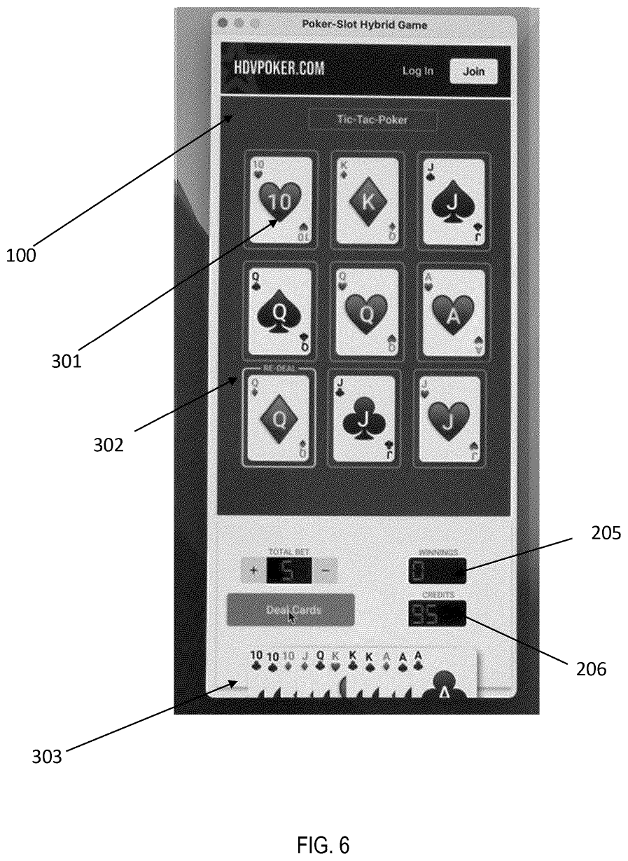

As shown in FIG. 6, once the “deal cards” button 204 is selected by the user, the current wager is subtracted from the available credits of the user and cards 301 (selected at random from a predetermined set of available cards 301) are placed in each of the spaces 101. In the example of FIG. 6, for instance, the amount of the current wager (5 credits) is displayed in the “total bet” window 204 and was subtracted from the available credits of the user (displayed in the “credits” window 206). In some embodiments, the system only provides functionality for the user to change the current wager before the cards 301 are dealt. Accordingly, in those embodiments, the “+” button 202 and the “−” button 203 may only provide functionality to change the current wager before the “deal cards” button 204 is selected.

In some embodiments, the user interface 100 displays the remaining cards 303 (i.e., the cards 301 from the predetermined set of available cards 301 that were not selected and displayed in any of the spaces 101).

After the cards are initially dealt, the system provides functionality for the user to re-deal some or all of the cards 301. For each of the spaces 101, the user interface 100 provides functionality for the user to indicate whether the user wishes to keep the displayed card 301 or functionality for the user to indicate whether the user wishes to discard the displayed card 301 and have a new card 301 (selected at random from the remaining cards 303 in the predetermined set) placed in that space 101. In the embodiment of FIG. 6, the user interface 100 provides functionality for the user to select each space 101 where the user wishes to discard the displayed card 301 and have a new card 301 displayed in that space 101. In those embodiments, the user interface 100 displays an indication (e.g., the “re-deal” border 302 of FIG. 6) identifying each of the spaces 101 where the user has provided instructions to discard the displayed card 301 and have a new card 301 placed in that space 101. In other embodiments, the user interface 100 provides functionality for the user to select each space 101 where the user wishes to keep the displayed card 301 and displays an indication (e.g., a “hold” border) identifying each of the spaces 101 where the user has provided instructions to keep the displayed card 301.

Once the “deal cards” button 204 is selected again by the user, additional cards 301 are selected (again at random) from the remaining cards 303 and placed in each of the spaces 101 identified by the user.

At the end of each round, a determination is made as to whether the user has formed one or more of the predetermined winning hands that are each associated with a predetermined prize amount. For each winning hand formed by the user, the predetermined prize amount associated with that winning hand is multiplied by the current wager specified by the user to form a total prize amount, which is displayed “winnings” window 205 and added to the user's pool of available credits (shown in the “credits” window 206).

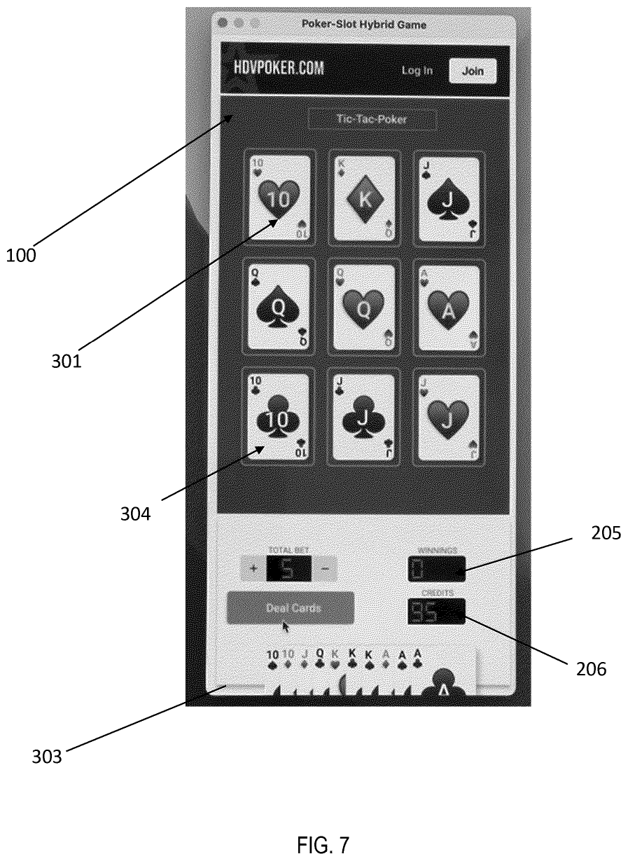

In the example of FIGS. 6-7, the user has decided to re-deal only a single card 301 (as indicated by the “re-deal” border 302 of FIG. 6) and has been re-dealt an additional card 304 from the remaining cards 303 (as shown in FIG. 7). In the example of FIG. 7, none of the hands formed by the user are one of the predetermined winning hands. Accordingly, the total winnings for that round is 0 (as indicated in the “winnings” window 205 of FIG. 7).

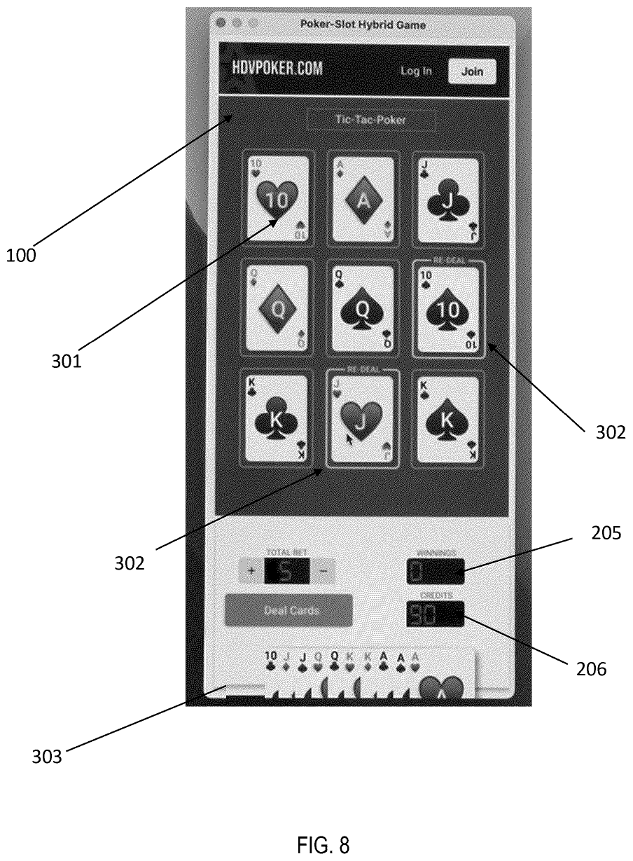

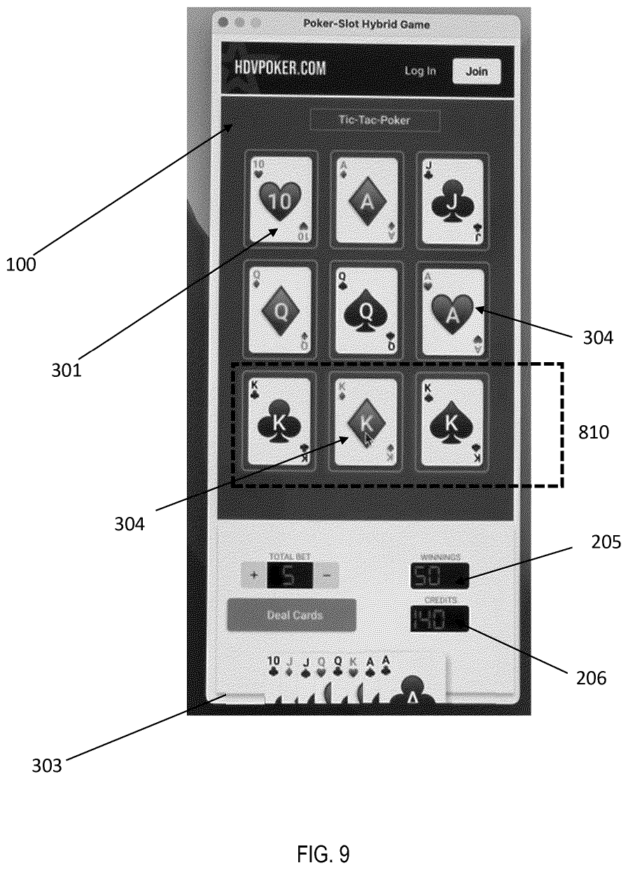

In the example of FIGS. 8-9, the user has decided to re-deal two cards 301 (as indicated by the “re-deal” borders 302 of FIG. 8) and has been re-dealt two additional cards 304 from the remaining cards 303 (as shown in FIG. 9). In the example of FIG. 9, the user has formed one winning hand 810 (in that example, three kings along the bottom row 102). Accordingly, the predetermined prize amount associated with that winning hand 810 (in this example 10 credits) is multiplied by the current wager specified by the user (in this example, 5 credits) to form a total prize amount (in this example, 50 credits), which is displayed “winnings” window 205 and added to the user's pool of available credits (shown in the “credits” window 206).

In some embodiments, users are permitted to re-deal the cards 301 multiple times (e.g., twice) in each round before a determination is made as to whether the user has formed one or more winning hands. In other embodiments, the user is only permitted to re-deal the cards 301 once per round.

In the embodiments of FIG. 1-9, the graphical user interface 100 includes nine spaces 101 arranged in a 3×3 grid. In other embodiments, however, the graphical user interface 100 may include any number of rows 102 and columns 103 (e.g., a 4×4 grid, a 5×5 grid, etc.) or an asymmetrical grid with a different number of rows 102 than columns 103 (e.g., a 3×4 grid, a 3×5 grid, a 4×5 grid, etc.).

In the embodiments of FIGS. 1-9, the user receives a prize for any of the predetermined winning hands 810 formed along any of eight pathways; specifically, any of the three rows 102, the three columns 103, or the two diagonal lines 104. In other embodiments, however, the available spaces 101 may form any number of pathways wherein a prize is awarded for a winning hand 810. Additionally, the system may provide functionality for the user to specify the number of pathways wherein a prize is awarded. Similar to the “play lines” or “paylines” of a traditional slot machine, for instance, the total amount wagered in each round may be determined by multiplying a wager amount specified by the user and the number of pathways specified by the user.

In the embodiments of FIGS. 1-9, the predetermined set of available cards 301 includes each of the five traditional face cards (i.e., 10s, jacks, queens, kings, and aces) in each of the four traditional suits (i.e., clubs, diamonds, hearts, and spades). In other embodiments, however, the set of available cards 301 may include any number of cards 301 in any number of suits. Additionally, in some embodiments, the predetermined set of available cards 301 may include wildcards (e.g., “jokers”) that can represent any other card 301 in the predetermined set, allowing the user to complete one or more of the predetermined winning hands 810 (or a winning hand 810 with a larger predetermined prize amount than would otherwise be created).

In the embodiments of FIGS. 1-9, each of the predetermined winning hands 810 includes three cards 301. In other embodiments, however, one or more of the predetermined winning hands 810 may include fewer than three cards 301 (e.g., a pair) and/or more than three cards (e.g., in embodiments wherein the user interface 100 includes more than three columns 103 and/or rows 102). The predetermined winning hands 810 may include three-of-a-kind (i.e., any three cards 301 having the same value), a flush (i.e., the requisite number of cards 301 in the same suit), a straight (i.e., the requisite number of cards with 301 values in sequential order regardless of suit), a straight flush (i.e., the requisite number of cards 301 in the same suit with values in sequential order). In some embodiments, predetermined winning hands 810 may include pairs (i.e., any two cards 301 having the same value). In embodiments wherein the user interface 100 includes more than three columns 103 and/or more than three rows 102, the predetermined winning hands 810 may include two pair (i.e., four cards 301 that form two sets of cards 301 wherein each set includes two cards 301 of the same value), four-of-a-kind (i.e., any four cards 301 having the same value), a full house (i.e., five cards 301 that form two sets of cards 301 that includes a pair and a three-of-a-kind), a royal flush (e.g., all four of the face cards and a ten in the same suit), etc.

The predetermined prize amount associated with each of the predetermined winning hands 810 may be inversely proportional to the likelihood of forming each of those predetermined winning hands 810. For instance, each redetermined prize amount may be inversely proportional to the odds of forming the associated winning hand 810, less a fee charged by a system operator for providing the game and accepting the wager from the user.

Embodiments of the disclosed system combine enjoyable aspects of traditional slot machine games (e.g., available spaces 101 that are part of more than one pathway, which can each be used to form winning hands 810) with enjoyable aspects of poker (e.g., the goal of forming one of a number of winning hands 810, deciding whether to hold or re-deal cards 301, deciding which winning hand to attempt to form 810, receiving higher payouts for winning hands 810 that are less likely to be formed, etc.).

In the embodiments of FIGS. 1-9, each of the available spaces 101 is filled with a symbol representing one of a predetermined set of cards 301. As described below, however, in other embodiments, the available spaces 101 may be filled with other symbols.

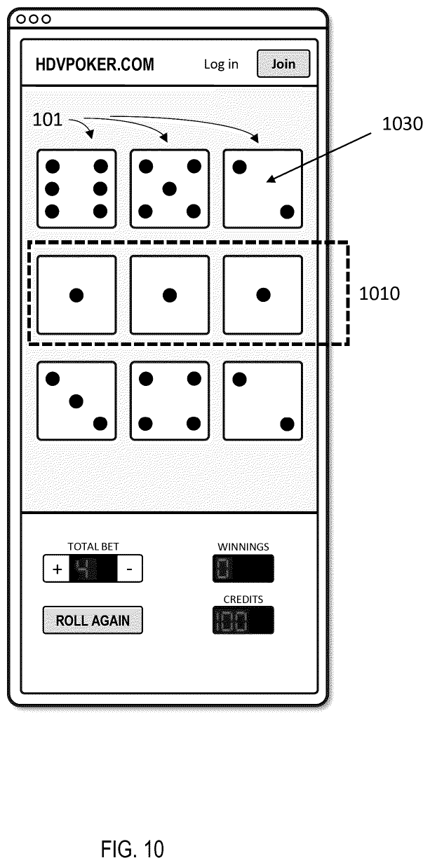

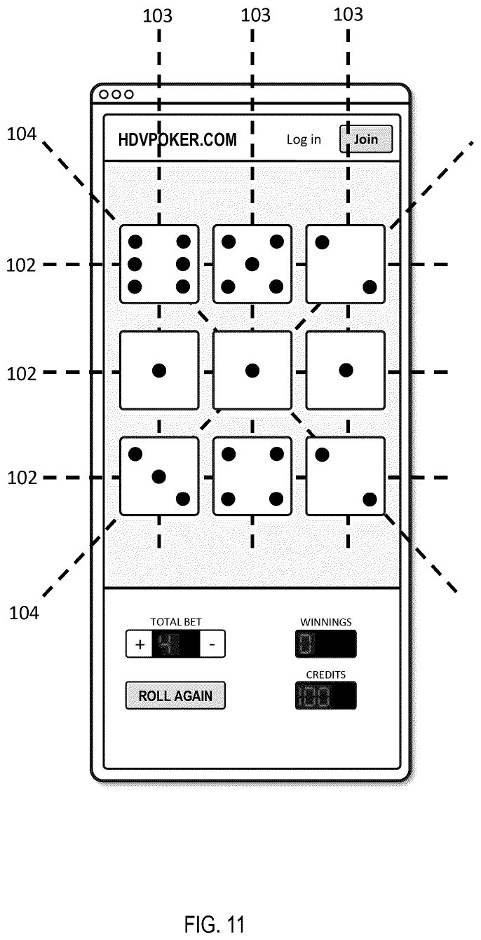

FIGS. 10-11 are example views of a user interface for the disclosed game according to other exemplary embodiments.

As shown in FIG. 10, for instance, the symbols placed in each of the available spaces 101 may represent each of the six sides of a traditional die 1030. Similar to the embodiments of FIGS. 1-9, the user is awarded a prize for forming one or more predetermined winning combinations 1010. Meanwhile, the user interface 100 may provide functionality for the user to discard one or more of the displayed dice 1030 and replace them with another symbol (in this example, to “re-roll” the dice). Unlike the embodiments of FIGS. 1-9 wherein a replacement card 301 is selected from the remaining cards 303 of a predetermined set, however, in the embodiments that use dice 1030, the system may randomly select one of the six sides of a traditional die 1030.

In the embodiments that use dice 1030, the predetermined winning combinations 1010 may include three-of-a-kind (i.e., three dice 1030 having the same value), a pair (i.e., two dice 1030 having the same value), a straight (i.e., the requisite number of dice 1030 with values in sequential order), etc. In embodiments wherein the user interface 100 includes more than three columns 103 and/or more than three rows 102, the predetermined winning combinations 1010 may include two pair (i.e., four dice 1030 that form two sets of dice 1030 wherein each set includes two dice 1030 of the same value), four-of-a-kind (i.e., four dice 1030 having the same value), a full house (i.e., five dice 1030 that form two sets of dice 1030 that includes a pair and a three-of-a-kind), five-of-a-kind (five dice 1030 having the same value), etc.

Again, each of those predetermined winning combinations 1010 may be associated with a predetermined prize amount, which may be inversely proportional to the probability of forming each of those winning combinations 1010 (less a fee charged by a system operator for providing the game and accepting the wager from the user).

As shown in FIG. 11, just like the embodiments of FIGS. 1-9, the user receives the predetermined prize amount (multiplied by the current wager) for each winning combination 1010 formed along any row 102, column 103, and/or diagonal line 104.

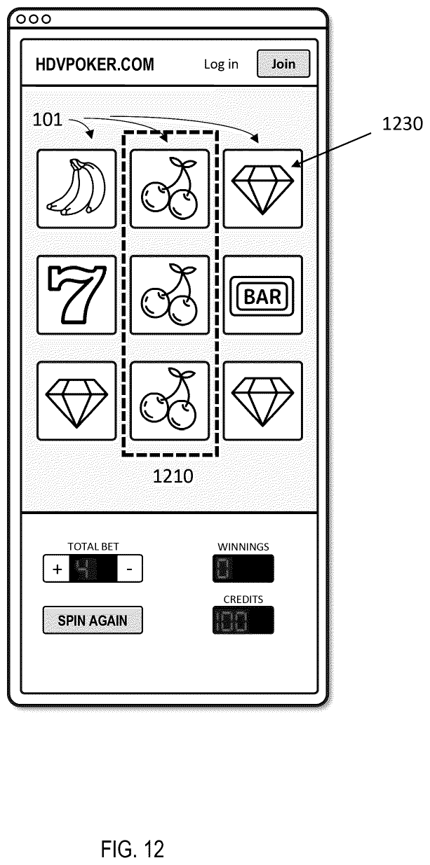

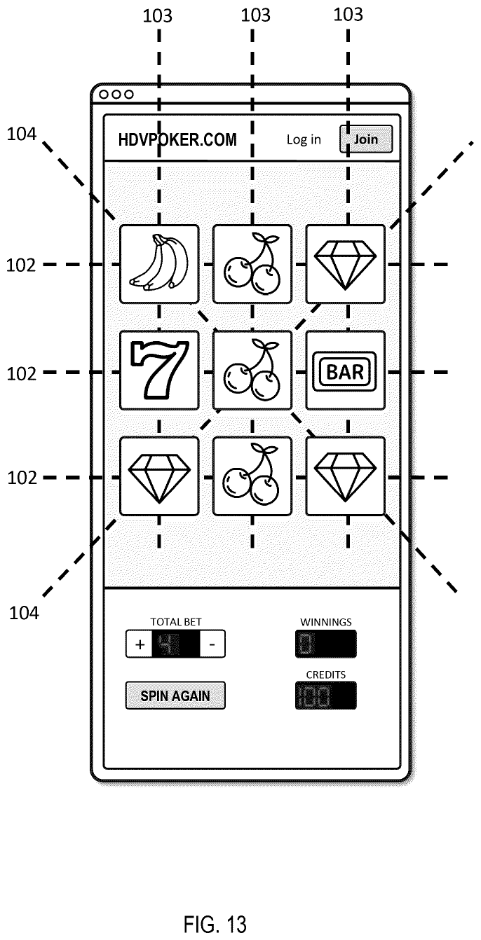

FIGS. 12-13 are example views of a user interface for the disclosed game according to other exemplary embodiments.

As shown in FIG. 12, for instance, the symbols placed in each of the available spaces 101 may be slot machine symbols 1230. Similar to the embodiments of FIGS. 1-9, the user interface 100 may provide functionality for the user to discard one or more of the displayed slot machine symbols 1230 and replace them with another symbol 1230 (in this example, to “re-spin” virtual reels). In embodiments that use slot machine symbols 1230, the system may randomly select one of the slot machine symbols 1230. Unlike the embodiments that use dice 1030, however, the probability of selecting each of the slot machine symbols 1230 may not be equal.

In the embodiments that use slot machine symbols 1230, the predetermined winning combinations 1210 may include three of the same symbol 1230 (e.g., three cherries, three diamonds, three bars, three bells, etc.), two of the same symbol 1230, or any other predetermined combination of symbols 1230. As shown in FIG. 13, the user receives the predetermined prize amount (multiplied by the current wager) for each winning combination 1210 formed along any row 102, column 103, and/or diagonal line 104. Again, each of those predetermined winning combinations 1210 may be associated with a predetermined prize amount, which may be inversely proportional to the probability of forming each of those winning combinations 1210 (less a fee charged by a system operator for providing the game and accepting the wager from the user). For instance, the system may be configured such that the probability of a diamond being displayed is less than the probability of a cherry being displayed, in which case the predetermined prize amount for three diamonds may be higher than the predetermined prize amount for three cherries.

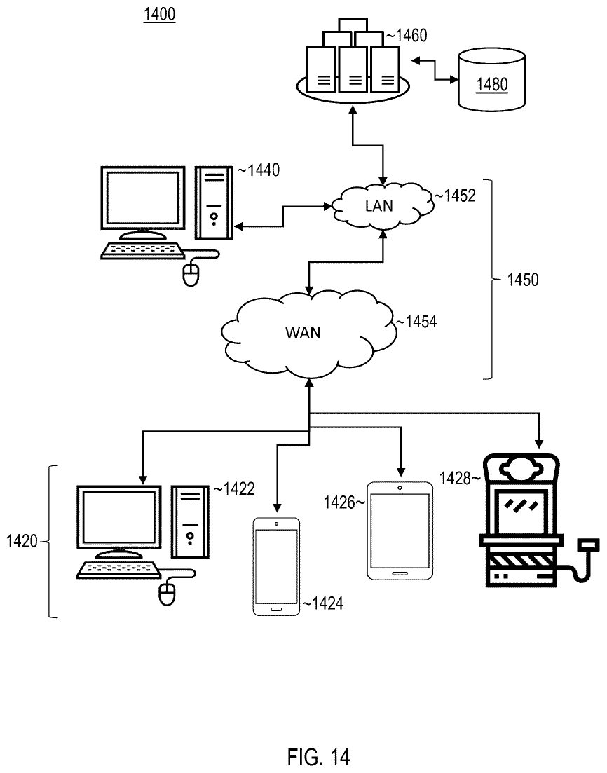

FIG. 14 is a diagram of an architecture 1400 of the disclosed platform according to exemplary embodiments.

In the embodiments of FIG. 14, the architecture 1400 includes a server 1460 that communicates with client devices 1420 via one or more networks 1450. The server 1460 may be in communication with computer readable storage media 1480 via a wired connection, via one or more of the networks 1450, etc. The server 1460 may also be in communication with an operator interface 1440 via a wired connection, via one or more of the networks 1450, etc.

The server 1460 may include any suitable computing device that executes instructions to perform the functions described herein. The server 1460 may include, for example, a web server that provides a user interface that is accessible by the client devices 1420 using a web browser. Additionally or alternatively, the server 1460 may include an application server that makes software executed by the server 1460 accessible to a software program executed by the client devices 1420. The application server may be a mobile application server that makes software executed by the server 1460 accessible to a mobile application running executed by the client devices 1420.

The networks 1450 may include local area networks 1452, wide area networks 1454 (e.g., the Internet), etc.

The computer readable storage media 1480 may include any non-transitory hardware storage medium, such as a hard disk, solid-state memory, etc.

The client devices 1420 may include any suitable computing device that executes instructions to send and receive data to/from the server 1460 and provides a graphical user interface (e.g., the graphical user interface 100 described above) to receive instructions from a user and display information to that user. The remote computing devices 1420 may include (desktop or notebook) personal computers 1422, smartphones 1424, tablet computers 1426, and/or stand-alone computing devices 1428 (e.g., similar to video poker machines or video slot machines). Similarly, the operator interface terminal 1440 may be any suitable computing device that executes instructions to send and receive data to/from the server 1460 and provides a graphical user interface to receive instructions from an operator and display information to that operator.

The client devices 1420 may be co-located with the server 1420 and/or the operator interface terminal 1440, for example at a licensed casino. In those instances, the client devices 1420 may communicate with the server 1420 and/or the operator interface terminal 1440 via a local area network 1452. In other embodiments, the client devices 1420 may communicate with the server 1420 and/or the operator interface terminal 1440 via a wide area network 1454, for example the Internet.

While preferred embodiments have been described above, those skilled in the art who have reviewed the present disclosure will readily appreciate that other embodiments can be realized within the scope of the invention. Accordingly, the present invention should be construed as limited only by any appended claims.

What is claimed is:

1. A platform for providing a poker-slot hybrid game, the platform comprising:
a graphical user interface that:
displays a plurality of spaces arranged in rows and columns, the plurality of spaces forming pathways that include each of the rows and each of the columns;
provides functionality for a user to specify a current wager that is subtracted from a pool of available credits of the user;
displays a symbol randomly selected from a predetermined set of symbols in each of the spaces; and
provides functionality for the user to identify one or more of the displayed symbols for replacement; and
a hardware computer processor that:
replaces each of the identified symbols with a replacement symbol randomly selected from the predetermined set of symbols;
determines whether the displayed symbols along each of the pathways form one or more of a predetermined set of winning combinations, each of the winning combinations being associated with a predetermined prize amount;
calculates a total winnings by multiplying the current wager specified by the user by the predetermined prize amount associated with each of the winning combinations formed in each of the pathways; and
adds the total winnings to the pool of available credits of the user.

2. The platform of claim 1, wherein:
the plurality of spaces are arranged in an equal number of rows and columns, including a top-left space, a top-right space, a bottom-left space, and a bottom-right space; and
the pathways further include two diagonal lines from the top-left space to the bottom-right space and from the bottom-left space to the top-right space.

3. The platform of claim 1, wherein the predetermined set of symbols depict a predetermined set of playing cards, each of the playing cards having one of a plurality of values in one of four suits.

4. The platform of claim 3, wherein the plurality of spaces are arranged in three rows and three columns.

5. The platform of claim 4, wherein each winning combination comprises three playing cards having the same value.

6. The platform of claim 4, wherein the set of winning combinations includes three cards having the same value, three cards having sequential values, or three cards in the same suit.

7. The platform of claim 6, wherein the set of winning combinations further includes two cards having the same value.

8. The platform of claim 3, wherein each replacement symbol is randomly selected from a set of remaining playing cards formed by removing each of the displayed playing cards.

9. The platform of claim 8, wherein the graphical user interface displays each of the remaining playing cards.

10. The platform of claim 1, wherein the predetermined set of symbols comprise depictions of six sides of a die, each of the sides of the die representing a value from 1 to 6.

11. The platform of claim 10, wherein the hardware computer processor executes instructions such that each of the six depictions of the six sides of the die have an equal probability of being randomly selected.

12. The platform of claim 10, wherein:
the plurality of spaces are arranged in three rows and three columns; and
the set of winning combinations comprises three dice representing the same value.

13. The platform of claim 12, wherein the set of winning combinations further includes three dice representing sequential values.

14. The platform of claim 1, wherein the predetermined set of symbols depict slot machine symbols.

15. The platform of claim 14, wherein the hardware computer processor executes instructions such that the slot machine symbols have an unequal probability of being randomly selected.

16. The platform of claim 14, wherein the predetermined prize amount associated with each of the winning combinations in inversely proportional to the probability of forming the winning combination.

17. The platform of claim 1, wherein the functionality to identify one or more of the displayed symbols for replacement comprises:
functionality for the user to mark symbols that are to be replaced; or
functionality for the user to mark symbols that are not to be replaced.

18. A computer-implemented method for providing a poker-slot hybrid game, the method comprising:
providing a graphical user interface that includes a plurality of spaces arranged in rows and columns, the plurality of spaces forming pathways that include each of the rows and each of the columns;
providing functionality for a user to specify a current wager that is subtracted from a pool of available credits of the user;
displaying a symbol randomly selected from a predetermined set of symbols in each of the spaces;
providing functionality for the user to identify one or more of the displayed symbols for replacement;
replacing each of the identified symbols with a replacement symbol randomly selected from the predetermined set of symbols;
determining whether the displayed symbols along each of the pathways form one or more of a predetermined set of winning combinations, each of the winning combinations being associated with a predetermined prize amount;
calculating a total winnings by multiplying the current wager specified by the user by the predetermined prize amount associated with each of the winning combinations formed in each of the pathways; and
adding the total winnings to the pool of available credits of the user.

19. Non-transitory computer readable storage media storing instructions that, when executed by a hardware computing system, cause the hardware computing system to:
provide a graphical user interface that includes a plurality of spaces arranged in rows and columns, the plurality of spaces forming pathways that include each of the rows and each of the columns;
provide functionality for a user to specify a current wager that is subtracted from a pool of available credits of the user;
display a symbol randomly selected from a predetermined set of symbols in each of the spaces;
provide functionality for the user to identify one or more of the displayed symbols for replacement;
replace each of the identified symbols with a replacement symbol randomly selected from the predetermined set of symbols;
determine whether the displayed symbols along each of the pathways form one or more of a predetermined set of winning combinations, each of the winning combinations being associated with a predetermined prize amount;
calculate a total winnings by multiplying the current wager specified by the user by the predetermined prize amount associated with each of the winning combinations formed in each of the pathways; and
add the total winnings to the pool of available credits of the user.
